(19) United States
(12) Patent Application Publication
(10) Pub. No.: US 2006/0208370 A1
(43) Pub. Date: Sep. 21, 2006

(54) Fluid mixing device for tub and bath fluid mixing apparatus

(76) Inventor: Masatoshi Masuda, Kyoto-city (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/375,665

(22) Filed: Mar. 14, 2006

(30) Foreign Application Priority Data
Mar. 18, 2005 (JP) 2005-078701

(51) Int. Cl. B01F 3/04

(52) U.S. Cl. 261/36.1; 261/151; 261/DIG. 27

(57) ABSTRACT

A fluid mixing device for a tub includes a closed mixing chamber having: a liquid inlet for introducing liquid into the mixing chamber; a gas inlet for introducing gas into the mixing chamber; and a gas-containing liquid outlet for discharging gas-containing liquid from the mixing chamber to a tub.

### BACKGROUND OF THE INVENTION

1. Field of the Invention

The present invention generally relates to a fluid mixing device for a tub which mixes gas and liquid in order to supply a tub.

2. Description of the Related Art

The device in Japanese Patent Laid-open No. 2001-145676 is known as a device which mixes gas with liquid to supply this kind of tub. The device disclosed in Japanese Patent Laid-open No. 2001-145676 provides a tub, a jet nozzle which sprays a jet flow to a tub, and an air intake which connects to the jet nozzle by means of an air flow pipe. Thus, according to the device disclosed in Japanese Patent Laid-open No. 2001-145676, it is possible to supply liquid which has mixed with the gas in the tub, and it is possible to enhance the effect of a warm bath.

However, for the device disclosed in Patent Reference 1, because there is simply only the supply of gas through the air flow pipe to the liquid which is to be supplied to the tub, it is not possible to mix enough gas. If it is not possible to mix enough gas, the gas from the liquid which was mixed in the tub will immediately flow out, and it will not be possible to achieve a sufficient warm bath effect.

### SUMMARY OF THE INVENTION

In view of the above, the present invention was made to solve at least one of the above-mentioned problems. An embodiment of the present invention has an object of providing a fluid mixing device for a tub for which there is mixed sufficient gas with the liquid that is supplied to the tub. Another embodiment of the present invention has an object of providing a bath fluid mixing apparatus including the fluid mixing device.

The present invention can be practiced in various ways including, but not limited to, embodiments described below, wherein numerals used in the drawings are used solely for the purpose of ease in understanding of the embodiments which should not be limited to the numerals. Further, in the present specification, different terms or names may be assigned to the same element, and in that case, one of the different terms or names may functionally or structurally overlap or include the other or be used interchangeably with the other.

In an aspect, the present invention provides a fluid mixing device for a tub comprising a closed mixing chamber (e.g., 20) having: (i) a liquid inlet (e.g., 172, 172′) for introducing liquid into the mixing chamber; (ii) a gas inlet (e.g., 177, 172′) for introducing gas into the mixing chamber; (iii) a pressure control valve (e.g., 89, 103, 104) for controlling pressure inside the mixing chamber; and (iv) a gas-containing liquid outlet (e.g., 171) for discharging gas-containing liquid from the mixing chamber to a tub. According to this embodiment, even through the structures are simple, gas can efficiently be mixed with liquid, and gas-containing liquid can be supplied to the tub. In an embodiment, the fluid may be gas, liquid, or gas-containing liquid; the liquid may be pure liquid or any liquid containing dissolved gas, gas bubbles, dissolved chemicals, dispersed chemicals, and/or other particles; the gas-containing liquid may be liquid containing dissolved gas and/or gas bubbles; the gas may be pure gas or any gas including unsaturated, saturated, supersaturated gas or steam. Further, mixing liquid and gas may mean contacting gas and liquid so that gas is dissolved in liquid, gas is dispersed in liquid as bubbles, or gas is partially dissolved and partially dispersed as bubbles in liquid.

The above aspect includes, but is not limited to, the following embodiments.

The fluid mixing device may further comprise a circulation device (e.g., 30) for mixing the liquid and gas in the mixing chamber, so that the introduction of gas into the liquid can efficiently be promoted. The circulation device may be disposed outside the mixing chamber. The circulation device may be provided with a heater (e.g., 61), so that an appropriate temperature can be maintained in the mixing chamber. In another embodiment, the circulation device (e.g., 22) may be disposed inside the mixing chamber. The circulation device may be water resident pump (e.g., 22). In this embodiment, the pump can be cooled in the liquid by transferring heat to the liquid, so that the temperature of the liquid can more efficiently be controlled.

The mixing chamber may have a convex portion (e.g., 21) for collecting gas therein, and an inlet (e.g., 79) of the circulation device (e.g., 30) arranged in the mixing chamber extends to the convex portion. This embodiment is effective when the circulation device generates jet flow because the jet flow can be generated without a need for using new gas from the outside.

The liquid inlet and the gas inlet may be constituted by a common inlet (e.g., 172′). The mixing chamber may further have an auxiliary gas-containing liquid outlet (e.g., 191, 192) for discharging gas-containing liquid from the mixing chamber to the tub, so that liquid having different amounts of gas due to unevenness of gas distribution in the liquid stored in the mixing chamber can additionally be supplied to the tub. In the above, the auxiliary gas-containing liquid outlet may be comprised of a first auxiliary gas-containing liquid outlet (e.g., 191) provided at an upper portion of the mixing chamber and a second auxiliary gas-containing liquid outlet (e.g., 192) provided at a lower portion of the mixing chamber.

The mixing chamber may further have a gas outlet (e.g., 193) for discharging gas from the mixing chamber and returning the gas to the gas inlet (e.g., 177).

The gas-containing liquid inlet (e.g., 172) may extend inside the mixing chamber. The extended portion (e.g., 150) may be tubular and may have multiple holes (e.g., 151) for discharging liquid outwardly from the inside of the portion through the holes. The extended portion may have a length which is greater than a half of a depth of the mixing chamber. In the above, a portion of the extended portion which is immersed in the liquid can enhance mixing of gas and liquid by generating convection flow within the mixing chamber. Further, a portion of the extended portion which is not immersed in the liquid in the mixing chamber can promote supply of gas into the liquid within the mixing chamber.

In another aspect, the present invention provides a bath fluid mixing system comprising: (I) a tub (e.g., 10) for storing liquid; (II) a mixing chamber (e.g., 20) for mixing gas into liquid; (III) a liquid supply path (e.g., 71) for supplying gas-containing liquid to the tub from the mixing chamber; (IV) a liquid recovery path (e.g., 72) for recovering liquid from the tub to the mixing chamber; (V) a liquid supply section (e.g., 50) for supplying liquid to a liquid circulation loop constituted by the mixing chamber, the supply path, the tub, and the recovery path; (VI) a gas supply section (e.g., 40) for supplying gas to the supply path or the mixing chamber; and (VII) a circulation device (e.g., 30) for mixing the liquid and gas in the mixing chamber. In the above, the mixing chamber can be any one of the aforesaid mixing chamber.

This aspect includes, but is not limited to, the following embodiments.

The circulation device may comprise: a circulating pump (e.g., 31); a flow-in path (e.g., 74) for flowing-in liquid to the circulating pump from the mixing chamber; and a flow-out path (e.g., 73) for flowing out liquid to the mixing chamber from the circulating pump. In this embodiment, it is possible to supply sufficient gas to the liquid which is supplied to the tub. The flow-in path or the flow-out path may be provided with a heater (e.g., 61). In this embodiment, it is possible to maintain an appropriate temperature within the tub.

The liquid supply section may be configured to supply hot water to the tub. In this embodiment, it is possible to supply liquid of an appropriate temperature to the tub. The gas supply section may be configured to supply carbon dioxide. In this embodiment, it is possible to elevate a warm bath effect.

The circulation device may comprise a water resident pump which is arranged inside the mixing chamber. In this embodiment, along with the possibility of cooling the pump itself in the water, there is the possibility of raising the temperature of the liquid which is retained in the interior of the mixing chamber.

The liquid recovery path may include a portion (e.g., 150) which extends inside the mixing chamber and which is tubular and has multiple holes (e.g., 151) for discharging liquid outwardly from the inside of the portion through the holes.

In all of the aforesaid embodiments, any element used in an embodiment can interchangeably or additionally be used in another embodiment unless such a replacement is not feasible or causes adverse effect. Further, the present invention can equally be applied to apparatuses and methods.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of the present invention will become apparent from the detailed description of the preferred embodiments which follow.

### BRIEF DESCRIPTION OF THE DRAWINGS

These and other features of the present invention will now be described with reference to the drawings of preferred embodiments which are intended to illustrate and not to limit the invention. The drawings are oversimplified for illustrative purposes.

FIG. 1 is an illustrative diagram which shows schematically the flow of the gas in the liquid of the bath fluid mixing apparatus which is related to Embodiment 1 of the present invention.

FIG. 2 is an illustrative block diagram which shows the principal electrical construction of the bath fluid mixing apparatus which is related to Embodiment 1 of the present invention.

FIG. 3 is an illustrative flow diagram which shows the mixing process of the liquid and gas by the bath fluid mixing apparatus which is related to Embodiment 1 of the present invention.

FIG. 4 is an illustrative diagram which shows the perimeter of the mixing chamber 20 for the mixing process of Embodiment 1.

FIG. 5 is an illustrative diagram which shows the perimeter of the mixing chamber 20 for the mixing process of the Embodiment 1.

FIG. 6 is an illustrative diagram which shows the perimeter of the mixing chamber 20 for the process of mixing for the Embodiment 1.

FIG. 7 is an illustrative diagram which shows schematically the flow of the gas and liquid of the bath fluid mixing apparatus which is related to Embodiment 2 of the present invention.

FIG. 8 is an illustrative diagram which shows schematically the flow of the gas and liquid of the bath fluid mixing apparatus which is related to Embodiment 3 of the present invention.

FIG. 9 is an illustrative flow diagram which shows the process of mixing of the liquid and the gas by the bath fluid mixing apparatus which is related to Embodiment 3 of the present invention.

FIG. 10 is an illustrative diagram which shows the perimeter of the mixing chamber 20 for the mixing process of Embodiment 3.

FIG. 11 is an illustrative diagram which shows the perimeter of the mixing chamber 20 for the mixing process of Embodiment 3.

FIG. 12 is an illustrative diagram which shows the perimeter of the mixing chamber 20 for the mixing process of Embodiment 3.

FIG. 13 is an illustrative diagram which shows the perimeter of the mixing chamber 20 for the mixing process of Embodiment 4.

FIG. 14 is an illustrative diagram which shows the perimeter of the mixing chamber 20 for the mixing process of Embodiment 4.

FIG. 15 is an illustrative diagram which shows the perimeter of the mixing chamber 20 for the mixing process of Embodiment 4.

FIG. 16 is an illustrative diagram which shows schematically the flow of the liquid and the gas for the bath fluid mixing apparatus which is related to Embodiment 5 of the present invention.

FIG. 17 is an illustrative diagram which shows the perimeter of the mixing chamber 20 for the mixing process of Embodiment 5.

FIG. 18 is an illustrative diagram which shows the perimeter of the mixing chamber 20 for the process of mixing for other embodiments.

FIG. 19 is an illustrative diagram which shows schematically the flow of the gas in the liquid for the bath fluid mixing apparatus which is related to Embodiment 6 of the present invention.

FIG. 20 is an illustrative diagram which shows the perimeter of mixing chamber 20 for the mixing process of Embodiment 6.

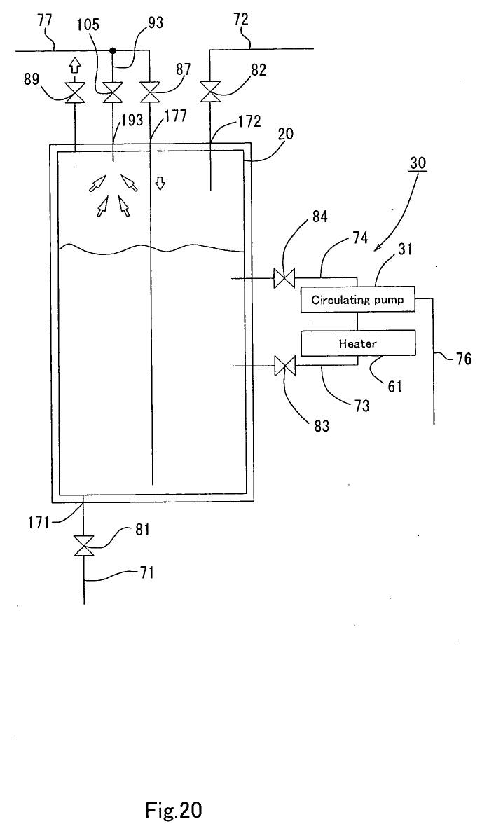

FIG. 21 is an illustrative partial cross-sectional view which shows from the side the supply pipe 150 for connection with the pipe 72.

FIG. 22 is an illustrative diagram which shows a structure around the supply pipe 150.

Explanatory of the Symbols is as follows: 10—tub; 20—mixing chamber; 21—air collection section; 22—water-resident pump; 30—circulation means; 31—circulation pump; 40—gas supply means; 50—liquid supply means; 61—heater; 62—flow sensor; 71—supply path; 72—pipe; 73—flow-in path; 74—flow-out path; 75—pipe; 76—pipe; 77—pipe; 78—pipe; 79—pipe; 81—open close valve; 82, . . . , 89—open close valve; 91, . . . , 93—pipe; 101, . . . , 105—open close valve; 110—control section; 111—ROM; 112—RAM; 113—CPU; 114—interface; 120—tub flow sensor; 130—mixing chamber flow sensor; 140—counter; 150—supply pipe; 151—hole; 161—circulation pump; 162—circulation pump; 171—gas-containing liquid outlet; 172, 172′—liquid inlet; 177—gas inlet; 191, 192—auxiliary gas-containing liquid outlet; 193—gas outlet.

### DETAILED DESCRIPTION OF THE PREFERRED EMBODIMENT

The present invention will be explained with respect to preferred embodiments and drawings. However, the preferred embodiments and drawings are not intended to limit the present invention. Further, the present invention relates not only to a bath fluid mixing apparatus but also to an element or elements of the apparatus such as a fluid mixing device which is included in the apparatus.

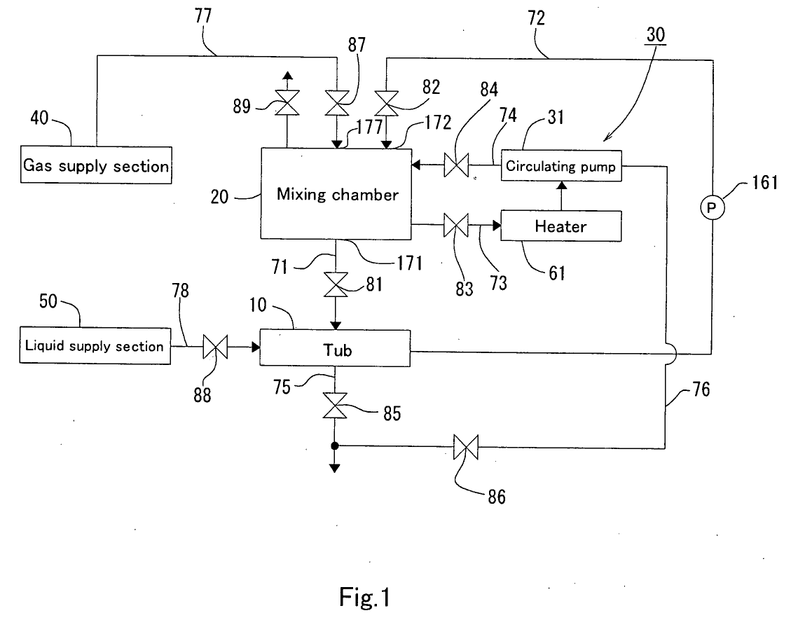

FIG. 1 is an illustrative diagram which shows schematically the flow of the gas and liquid of the bath fluid mixing apparatus which is related to Embodiment 1 of the present invention.

The bath fluid mixing apparatus which is related to Embodiment 1 of the present invention provides a tub 10, a mixing chamber 20, a liquid supply path 71 for supplying liquid to tub 10 from mixing chamber 20, a liquid pipe 72 (liquid recover path) for recovering the liquid in the mixing chamber 20 from the tub 10, and a liquid supply section 50 which supplies liquid to the tub 10 by means of the pipe 78 in order to supply liquid in the circulating path of the liquid which arrives at the mixing chamber 20 by means of the supply path 71 from the mixing chamber 10 and the tub 10 and the pipe 72, the gas supply section 40 which supplies gas to the mixing chamber 20 by means of a pipe 77 (gas supply path), and the circulating means 30 for mixing the liquid and gas in the mixing chamber 10.

Preferably, the mixing chamber is constructed air-tightly so that gas does not dissipate from the mixing chamber. The liquid pipe 72 is connected to a liquid inlet 172 of the mixing chamber 20, and the pipe 77 is connected to a gas inlet 177 of the mixing chamber 20. Further, a gas-containing liquid outlet 171 of the mixing chamber is connected to the liquid supply path 71. The mixing chamber is provided with a pressure control valve 89 for controlling pressure inside the mixing chamber 20, in order to promote liquid and gas flow fluid-tightly through the mixing chamber. In an embodiment, the pressure control valve 80 can be omitted if the mixing chamber's fluid tightness is not high.

In the liquid pipe 72, a circulation pump 161 is provided, so that the liquid from the tub can be supplied to the mixing chamber.

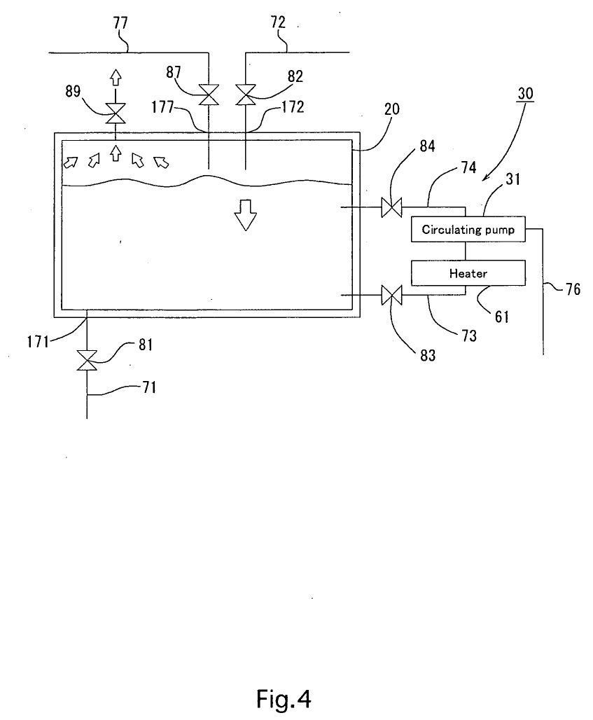

The circulating means 30 provides a circulating pump 31, a flow in path 73 for flowing in liquid to the circulating pump 31 from the mixing chamber 20, and a flow out path 74 for flowing out liquid to the mixing chamber 20 from the circulating pump 31. In addition, and the circulating means 30, a heater 61 is established as a heating means for the flow in path 73 (FIGS. 4-6). Because of this heater is possible to maintain at an appropriate temperature the tub 10. Moreover, the circulating pump 31 may be arranged on the inside of the mixing chamber 20, and may be arranged on the outside of mixing chamber 20.

The tub 10 and the circulating pump 31 are respectively connected with the pipe 75 and pipe 76 for discharging liquid to the outside of the device.

Moreover, the supply path 71, the pipe 72, the flow in path 73, the flow out path 74, the pipe 75, the pipe 76, the pipe 77, and the pipe 78 are respectively connected to the open/close valve 81, 82, 83, 84, 85, and 86, 87, and 88. Because of these connections, it is possible to control the flow in and out amounts of the liquid in the gas respectively to the tub 10, the mixing chamber 20, the circulating means 30, an outside the device.

In addition, the mixing chamber 20 is designed for the possibility of retaining 1/2 or more (including 2/3, 1/1, 3/2, 2/1, and ranges between any two numbers of the foregoing) of the liquid of the tub 10. Because of this retention capability, it is possible to process a large amount of liquid for supplying the tub 10 for the mixing chamber 20, and as explained afterwards, supply becomes possible by stabilizing the warm water that mixed the carbon dioxide. If the tub is a personal tub, the liquid stored in the tub may be 10-50 litters, and accordingly, the capacity of the mixing chamber can be determined. If the mixing capacity of the mixing chamber is high, the size of the mixing chamber can be as small as less than 1/2 (1/3, 1/4, 1/5, and ranges between any two numbers of the foregoing) of the liquid of the tub. In an embodiment, the capacity of the mixing chamber may be in the range of 5-50 litters (including 10 litters, 20 litters, 30 litters, 40 litters, and ranges between any two numbers of the foregoing, preferably 10-30 litters).

In addition, there is formed an opening section in the mixing chamber 20 in order to draw air upward. This opening section is connected with the open close valve 89 and is freely controlled to open and close.

The liquid supply section 50 need not be connected to the tub but can be connected to any position in a loop constituted by the mixing chamber 20, the liquid supply path 71, the tub 10, and the liquid pipe 72, as long as liquid can be supplied from an external source to the loop.

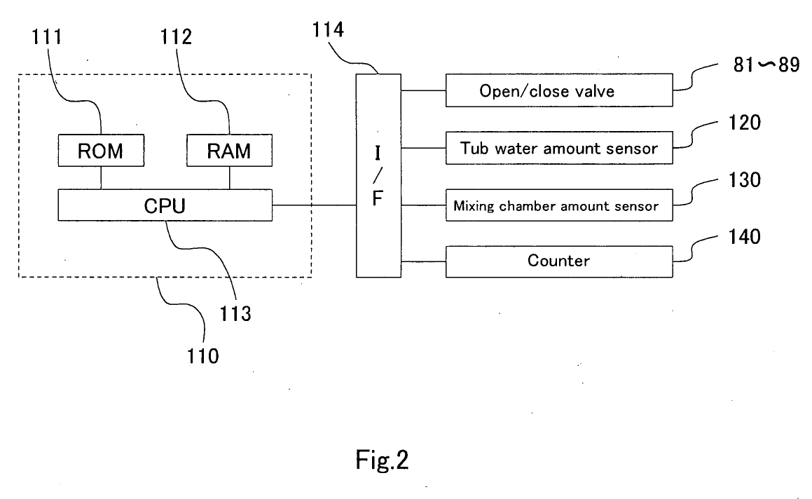

FIG. 2 is an illustrative block diagram which shows the principal electrical construction of the bath fluid mixing apparatus which is related to Embodiment 1 of the present invention.

This bath fluid mixing apparatus provides a control section 110 which comprises a ROM in which the necessary programs for control of the device are stored, a RAM 112 which temporarily stores data when controlling, and a CPU 113 which executes logical calculations. This control section 110 connects by means of the interface 114 the open/close valves 81-89 in the bath fluid mixing apparatus, the tub water amount sensor 120 which can detect the water amount of the tub 10, the mixing chamber water amount sensor which can detect the amount of water of the mixing chamber 20 and the counter 140 which can count the later explained setup periods T1 and T2.

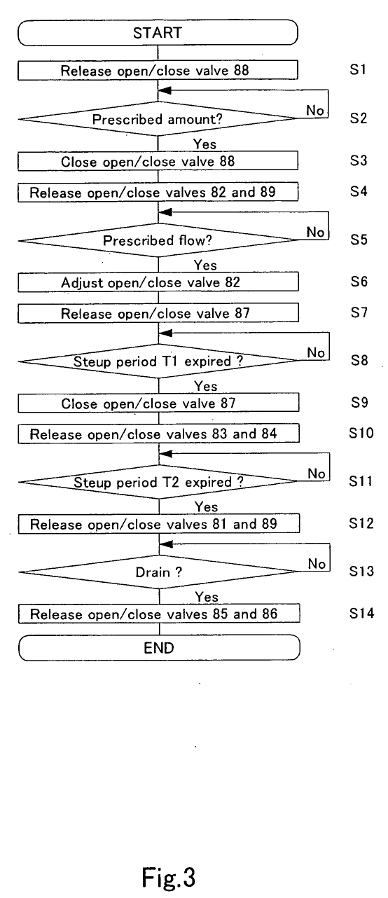

FIG. 3 is a flow diagram which shows the mixing process of the liquid and the gas by the bath fluid mixing apparatus which is related to Embodiment 1 of the present invention. In addition, FIGS. 4-6 are explanatory diagrams which show the mixing chamber 20's perimeter for the mixing process. Moreover, it is assumed that warm water is the liquid which is supplied from the liquid supply section 54 Embodiments 1-3 of the present invention which is explained below, and that the gas which is supplied from the gas supply section 40 is carbon dioxide.

When there is mixing of the warm water and carbon dioxide by utilizing is bath fluid mixing apparatus which is related to Embodiment 1 of the present invention, first, there is release of the open/close valve 88 which is shown in FIG. 1, and then there is supply of warm water to the tub 10 from the liquid supply section 50 (step S1). The liquid supply section 50 supplies the tub 10 through heating means such as boiling the water of the water pipe.

If the warm water that is supplied to the tub 10 of the liquid supply section 50 is over a specified amount, there is closing of the open close valve 88 (step S2, S3). It is possible to adjust the water amount that is retained in the tub 10 by controlling in this way.

Is shown in FIG. 4, along with drawing air from above the mixing chamber 20 by releasing the open close valves 82 and 89, there is supply of liquid to the mixing chamber 20 from the tub 10 by activating the circulation pump 161 (step S4).

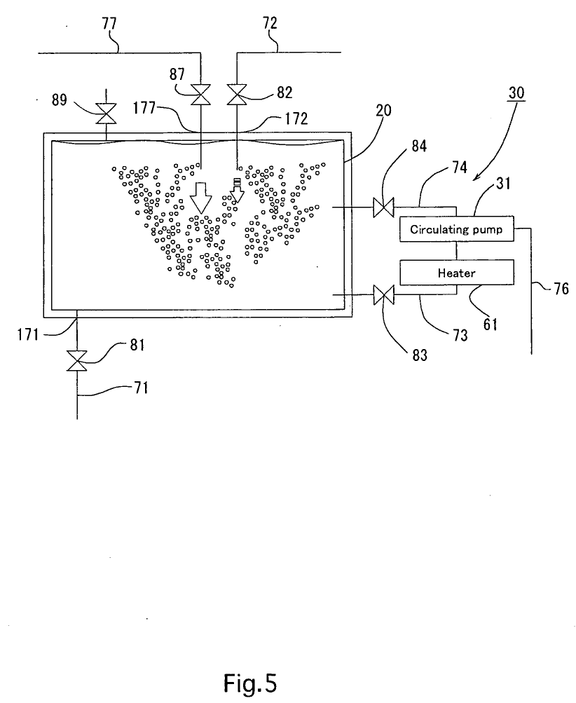

If the liquid that was supplied to the mixing chamber 20 reaches a prescribed height in the mixing chamber 20, there is closing of the open close valves 82 and 89, and along with stopping the drawing of air from above the mixing chamber 20, there is termination of the liquid supply within the mixing chamber 20 (step S5 and S6). When the liquid supply is terminated, the mixing chamber 20 is substantially or nearly filled up with the liquid as shown in FIG. 5. However, in an embodiment, the mixing chamber 20 need not be filled up with the liquid, but may be filled as much as an lower end of the gas inlet 177 is immersed in the liquid, so that when gas is introduced into the mixing chamber 20, the liquid bubbles with the gas. A lower end of the liquid inlet 172 need not be immersed in the liquid. In another embodiment, the mixing chamber is not filled up with the liquid, and the lower end of the gas inlet 177 is not immersed in the liquid in the mixing chamber, wherein the liquid in the mixing chamber is circulated so that the liquid and gas can be mixed.

As shown in FIG. 5, there is the release of the open close valve 87, and the supplying of carbon dioxide to the mixing chamber 20 from the gas supply section 40 (step S7). By supplying the carbon dioxide in this way to the mixing chamber 20, is possible to elevate the warm bath effect. Moreover, the period T1 is predetermined as the supply period for the carbon dioxide to the mixing chamber 20 of the gas supply section 40. Because of this determination, the supply becomes easy to control. In an embodiment, the mixing chamber 20 is provided with a sensor which senses the liquid level.

At this time, the liquid and gas are continuously supplied to the mixing chamber 20, and convection flow is generated within the mixing chamber 20. From this convection flow, the liquid and gas which were supplied to the mixing chamber 20 are mixed.

If the setup period T1 has elapsed, the open close valve 87 closes, and the supply of carbon dioxide to the mixing chamber 20 from the gas supply section 40 stops (steps S8 and S9).

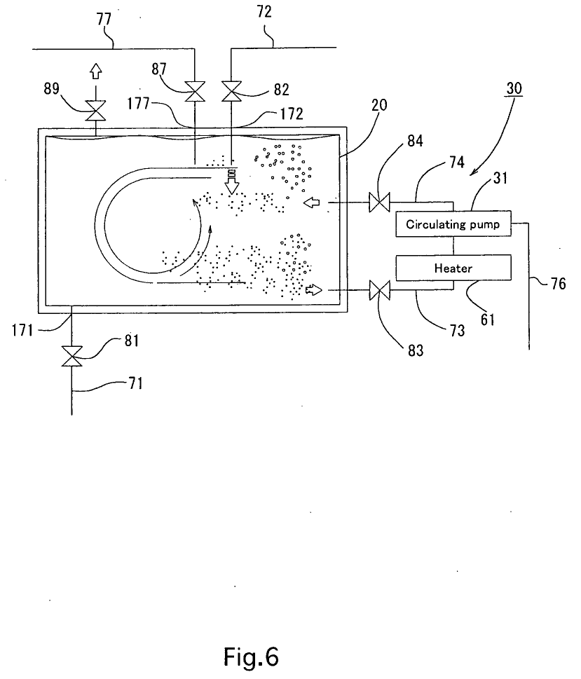

Afterwards, as shown in FIG. 6, along with the release of the open close valve 83, there is flow within the circulating means 30 which provides the heater 61 and the circulating pump 31 of warm water and carbon dioxide within the mixing chamber 20, and there is release of the open close valve 84, and once again flow out to the mixing chamber 20 of the warm water and carbon dioxide which flowed into the pumping means 30 (step S10). Because of these flows, is possible to sufficiently mix the warm water and the carbon dioxide within the mixing chamber 20. Moreover, the period T2 is predetermined as the circulating period which circulates by the circulating means 30 the warm water and carbon dioxide. Because of this determination, control becomes easy. If the capacity of the mixing chamber 20 is small, the circulating means 30 can be omitted.

If the setup period T2 elapses, there is release of the open close valve 81, and there is supply of the warm water that was mixed with the carbon dioxide to the tub 10 from the mixing chamber 20 via the liquid supply path 71 through the gas-containing liquid outlet 171 (steps S11 and S12). In addition, at this time, the open close valve 89 remains released. The warm water that was retained within the mixing chamber 20, by pressure from the atmosphere, flows out smoothly in the direction of the tub 10. If the mixing chamber 20 is disposed above the tub, the liquid can move by gravity. In that case, the gas-containing liquid outlet 171 is preferably provided at a bottom of the mixing chamber 20.

Moreover, if the warm water for supplying the tub 10 in the mixing chamber 20 becomes reduced, once again it is permitted to return to step S1, and initiate a return operation to step S4.

In addition, during the steps S10-S12, there is release of the open close valve 82, and there may be supply of warm water to the mixing chamber 20 from the tub 10. Furthermore, at this time, there is release of the open close valve 87, and there may be supply of carbon dioxide to the mixing chamber 20 from the gas supply section 40.

After the completion of these operations, what is desired to discharge the warm water that has accumulated in the mixing chamber 20 or the tub 10, there is release of the open close valves 85 and 86, and there's discharge of the warm water to outside the device (steps S13 and S14). Moreover, at this time, preferably, there is release of the open close valve 89, and supply of outside air to the mixing chamber 20.

According to the bath fluid mixing apparatus which is related to Embodiment 1, because the pipe 72 and pipe 77 are separately connected to the mixing chamber 20, it is possible to separately supplying liquid and gas to inside the mixing chamber 20. Because of this possibility, is possible to separately control liquid and gas.

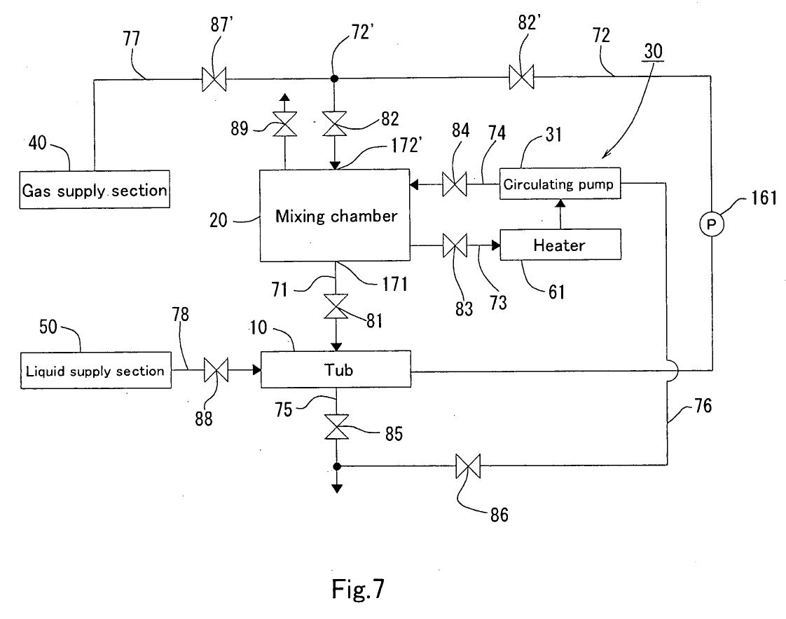

Below, there's an explanation, based on the drawings, for another embodiment of the present invention. FIG. 7 is a diagram which schematically shows the flow of the gas and liquid of the bath fluid mixing apparatus which is related to the Embodiment 2 of the present invention.

The bath fluid mixing apparatus which is related to the Embodiment 1 of the present invention becomes a structure in which there can be separate connections of the pipe 72 of the pipe 77 to the mixing chamber 20 and for the bath fluid mixing apparatus which is related to Embodiment 2 of the present invention, pipe 77 is connected to pipe 72, and only pipe 72 is connected to a liquid inlet 172′ of the mixing chamber 20 as a common inlet. This difference in connection represents the difference between Embodiment 2 and Embodiment 1. In addition, in order to control gas flow and liquid flow at a junction 72′ (preventing backflow at the junction 72′), an open close valve 82′ and an open close valve 87′ are provided in the liquid pipe 72 and the gas pipe 77, respectively.

According to the bath fluid mixing apparatus which is related to the Embodiment 2, it is possible to omit the open close valve 87 which is arranged between the pipe 77 in the mixing chamber 20 in the bath fluid mixing apparatus which is related to Embodiment 1, and it is assumed that this omission makes construction of the device easier.

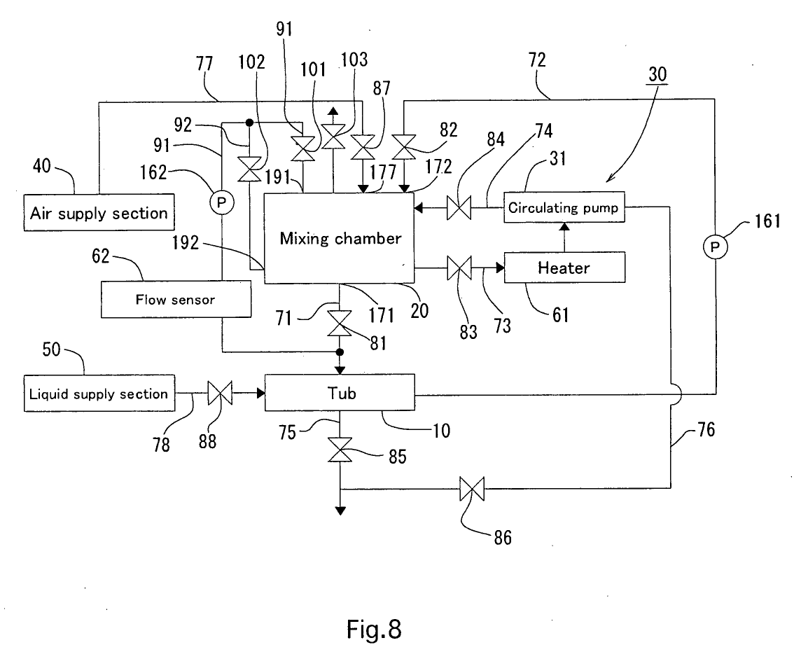

There is an illustrative based on the drawings of the bath fluid mixing apparatus which is related to Embodiment 3 of the present invention. FIG. 8 is a schematic diagram which shows the flow of the gas and liquid of the bath fluid mixing apparatus which is related to Embodiment 3 of the present invention.

The bath fluid mixing apparatus which is related to Embodiment 3 of the present invention provides, instead of the open close valve 89 which is related to Embodiment 1, an open close valve 103 for injecting air, a pipe 91, an open close valve 101 which connects to the pipe 91, and a pipe 92, and an open close valve 102 which connects with the pipe 92. The pipe 91 is connected to a first auxiliary gas-containing liquid outlet 191 of the mixing chamber 20, and the pipe 92 is connected to a second auxiliary gas-containing liquid outlet 192. In addition, the pipe 92 connects with the pipe 91, and the pipe 91 which is connected with the pipe 92 is further connected with the supply path 71.

From these connections, the gas and the liquid within the mixing chamber 20 are supplied to the tub 10 by means of the pipe 91 and the pipe 92. In addition, a pump 162 is provided in the pipe 91, and a flow sensor 62 within the pipe 91 is established so as to detect the water amount which flows within the pipe 91. Furthermore, the opening in the mixing chamber 20 for the pipe 91 is arranged on a top portion of the mixing chamber 20, and the opening on the mixing chamber 20 for the pipe 92 is arranged at a bottom of the mixing chamber 20. Lower ends of the first and second auxiliary gas-containing liquid outlets 191, 192 are immersed in the liquid in the mixing chamber 20 although the lower end of the first auxiliary gas-containing liquid outlets 191 is arranged close to the top of the mixing chamber 20, so that the liquid containing gas can be taken from an upper portion of the liquid and also from a lower portion of the liquid in the mixing chamber 20.

Because of this arrangement, it becomes possible for the warm water which accumulates within the mixing chamber 20 to flow into the respective pipes warm water which has a different mixing combination of carbon dioxide. Accordingly, as explained above, it is possible to supply warm water which has mixed with carbon dioxide to the appropriate degree in the tub 10.

Moreover, these open close valves 101, 102, 103, and the flow sensor 26, in the same way as with the other open close valves 81-88, are a lecture clique connected to the control section 110 by means of the interface 114 which is shown in FIG. 2.

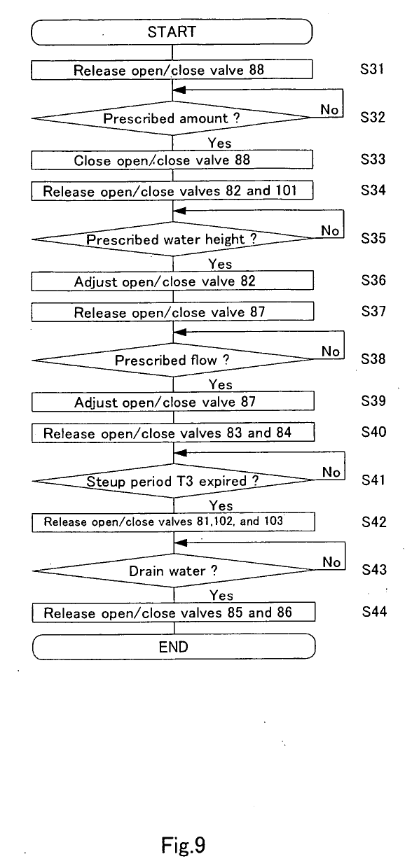

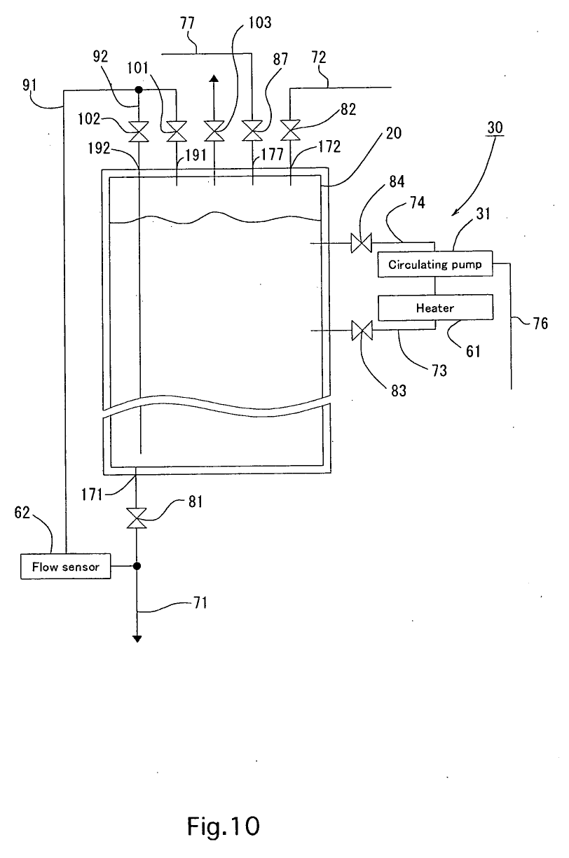

FIG. 9 is a flow diagram which shows the mixing process of the liquid and gas according to the bath fluid mixing apparatus which is related to Embodiment 3 of the present invention. In addition, FIGS. 10-12 are explanatory diagrams which show the border of the mixing chamber 20 for the mixing process.

When there is mixing of the warm water and carbon dioxide by using the bath fluid mixing apparatus which is related to Embodiment 3 of the present invention, first, there is release of the open close valve 88, and supply of warm water to the tub 10 from the liquid supply section 50 (step S31). If the warm water which was supplied to the tub 10 from the liquid supply section 50 exceeds a prescribed amount, the open close valve 88 closes (steps S32 and S33).

As shown in FIG. 10, along with releasing the open close valves 82 and 101, there is drawing of air from above the mixing chamber 20 by means of the pipe 91, there is supply of liquid to the mixing chamber 20 from the tub 10 by means of the pipe 72 (Step S34). In this step, if there is no liquid supply section is provided between the tub 10 and the mixing chamber 20, the open close valve 88 reopens to supply warm water to the mixing chamber 20 via the tub 10 while the pump 161 is activated.

If the warm water which is supplied to the mixing chamber 20 reaches a prescribed water level in the mixing chamber 20, there is adjustment of the open close valve 82 and by controlling the open close valve 82, there is adjustment of the supply of warm water in such a way as to decrease the supply amount of warm water to the mixing chamber 20 (steps S35 and S36).

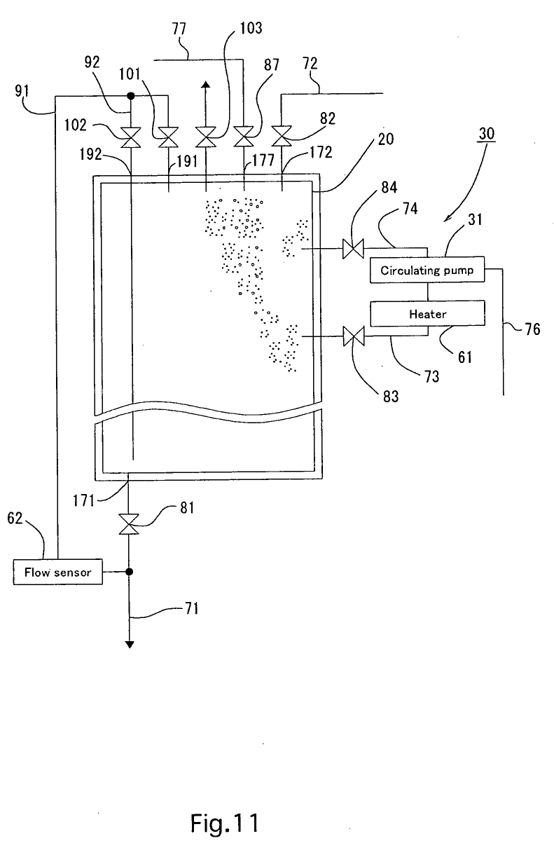

Next, as shown in FIG. 11, there is release of the open close valve 87, and supply of carbon dioxide to the mixing chamber 20 from the gas supply section 40.

If a water amount above a prescribed amount which was preset is detected by the flow sensor 62, by controlling the open close valve 87, there is adjustment of the supply of the gas in such a way as to decrease the supply amount of the gas towards the mixing chamber 20 from the gas supply section 40 (steps S38 and S39).

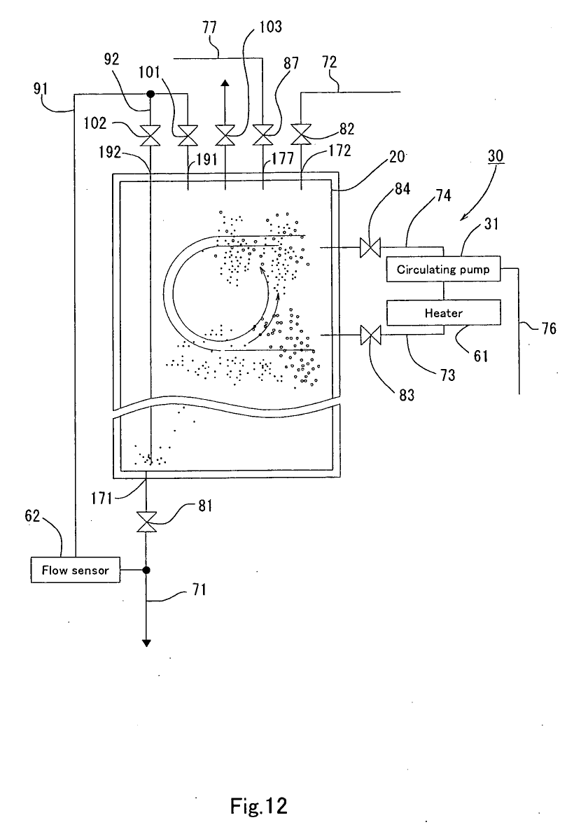

Afterwards, as shown in FIG. 12, along with the release of open close valve 83 and flow of the liquid and gas within the mixing chamber 20 to the circulating means 30 which provides the heater 61 and circulating pump 31, there is release of the open close valve 84, and once again flow out of the liquid and gas that flowed into the circulating means 30 to the mixing chamber 20 (step S40). Because of this circulation, it is possible to sufficiently mix the liquid and gas within the mixing chamber 20. Moreover, the preset period T3 was determined as the circulating period for which the liquid and gas were circulated by the circulating means 30.

If the set period T3 elapses, there is release of the open close valves 81 and 102, and supply and there is supply to the tub 10 from the mixing chamber 20 of liquid that was mixed with gas (steps S41 and S42). At this time, it becomes possible to supply the liquid that was mixed with gas to the tub 10 from the mixing chamber 10 by means of the pipes 91 and 92 and the supply path 71. Because the openings at the mixing chamber 21 for these pipes 91 and 92 and the supply path 71 are arranged at respectively different positions, warm water with differing concentrations of carbon dioxide are supplied to the tub 10 by means of the respective paths. In addition, at this time, there is release of the open close valve 103. From this release, the warm water that had been accumulating in the mixing chamber 20 smoothly flows out in the direction of the tub 10 from the pressure exerted by the air.

After completing these operations, when it is desired to discharge the warm water that was accumulating in the mixing chamber or tub 10, by releasing the open close valves 85 and 86, there is liquid discharge of the warm water outside the device (steps S43 and S44). Moreover, at this time, by releasing the open close valve 103, there is a supply of outside air to the mixing chamber 20.

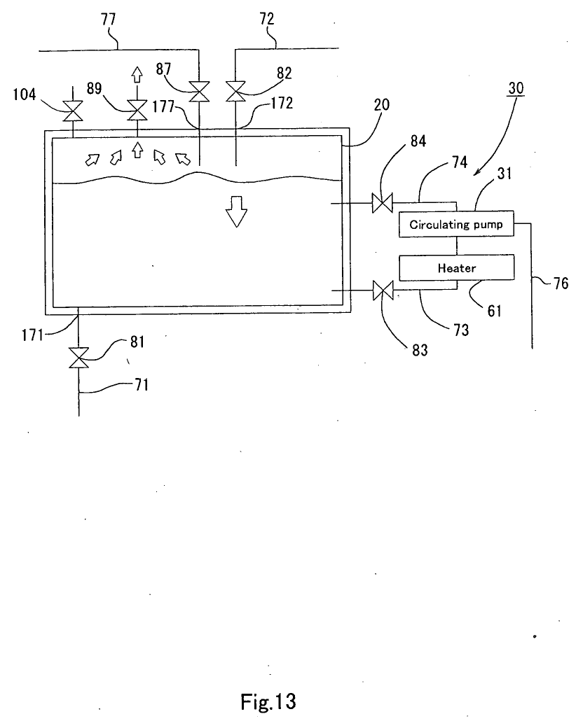

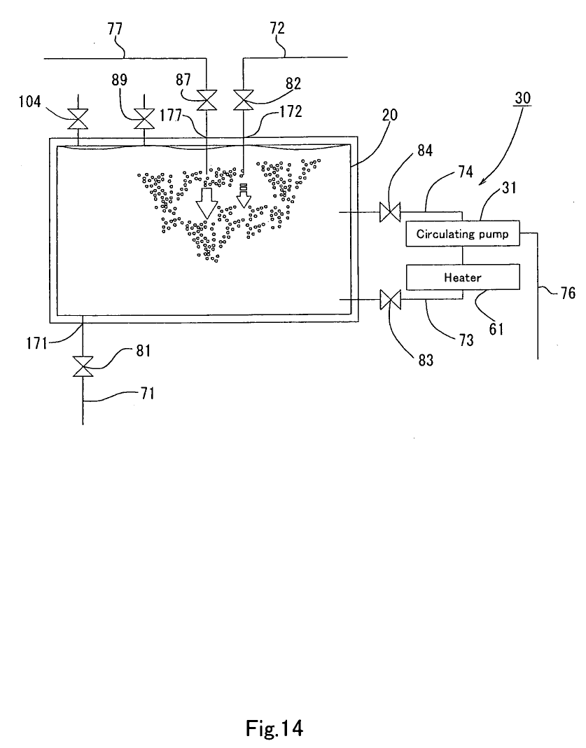

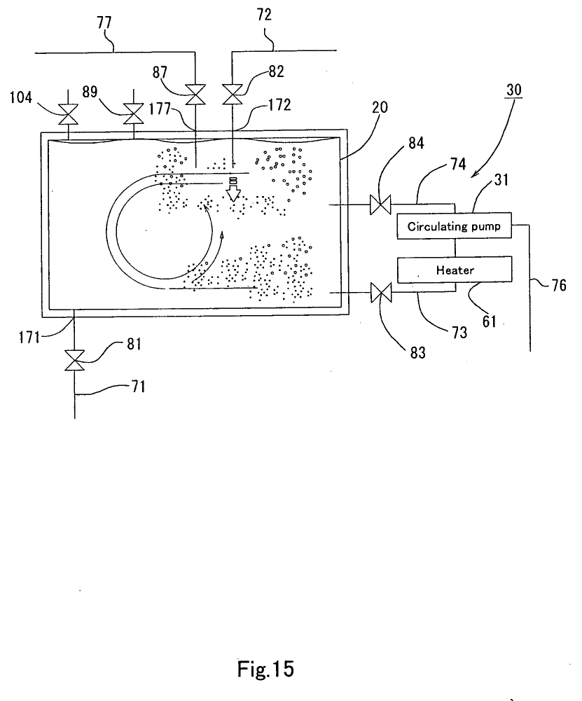

FIGS. 13-15 are explanatory diagrams which show the perimeter of the mixing chamber for the mixing process in the bath fluid mixing apparatus which is related to Embodiment 4 of the present invention.

The bath fluid mixing apparatus which is related to Embodiment 4 of the present invention provides an additional open close valve 104 to the bath fluid mixing apparatus which is related to Embodiment 1 of the present invention. The open close valve 89 is exclusively used, in the bath fluid mixing apparatus which is related to this Embodiment 4, to flow to the outside gas from the mixing chamber 20, and the open close valve 104 is exclusively used for flowing in gas from the outside to the mixing chamber 20.

By adopting a valve structure for the bath fluid mixing apparatus which is related to Embodiment 4 of the present invention, which is disclosed in, for example, Japanese Patent Laid-open No. 2004-067099 (the disclosure of which is incorporated herein by reference), in addition to easy construction, there results a structure which causes inflow of gas exclusively to the mixing chamber 20 from the outside. Moreover, the valve structure which is disclosed in Japanese Patent Laid-open No. 2004-067099 has a valve seat part which has a rough cylindrical shape whose formed circular opening part acts as a valve seat at the base, a ring-shaped part which is arranged on the inside of the valve seat part, a valve body which has a shape that corresponds with the circular-shaped opening part, and a plurality of connectors which connect the support part and the valve body, and from the flexibility of the plurality of connectors, the valve body provides a valve part of resin manufacture that is movably formed between the closed position which closes the opening part on the valve seat of said valve body and the release position which releases the opening part. However, the formation of the open close valve 104 is not limited to this kind of valve construction, and only when the pressure of the mixing chamber 20 becomes lower than the outside pressure is it permissible to have a structure that flows in gas to the mixing chamber 20 from the outside.

According to the bath fluid mixing apparatus which is related to Embodiment 4, it is possible to make the difference in pressure between the inside and outside of the mixing chamber small, and like the bath fluid mixing apparatus which is related to Embodiment 1, there is no release of the open close valve 89 when supplying warm water that has been mixed with carbon dioxide from the mixing chamber to the tub 10, and it becomes possible for the warm water which accumulates in the mixing chamber 20 to smoothly outflow from the mixing chamber to the tub 10.

Moreover, the above-described embodiments may arrange on the flow path 73 a heating means 63 for the circulating means 30, but may also have such an arrangement in the outflow path 74, and in the circulating path of the liquid which reaches the mixing chamber 20 by means of the supply path 71, the tub 10, and the pipe 72 from the mixing chamber 20 in addition to the circulating means 30. In addition, it is permissible to have a bath fluid mixing apparatus which does not provide a heating means 60.

In addition, for the above-mentioned embodiments, the open close valve 89 in the Embodiments 1 and 2 and the open close valve 103 in the Embodiment 3 are formed so as to be released when supplying liquid to the tub 10 from the mixing chamber 20, but when supplying liquid to the tub 10 from the mixing chamber 20, in order to prevent contact of the liquid and gas within the mixing chamber 20, it is desirable to construct so that there is no release. For example, only when discharging liquid which has accumulated within the mixing chamber 20 and tub 10 is it permissible to release the open close valve 89 and the open close valve 103. Moreover, when releasing in this way only during discharge, it is permissible to arrange the open close valve 103 for the Embodiment 3 at the pipe 91 or pipe 92.

There is an explanation concerning the bath fluid mixing apparatus which is related to Embodiment 5.

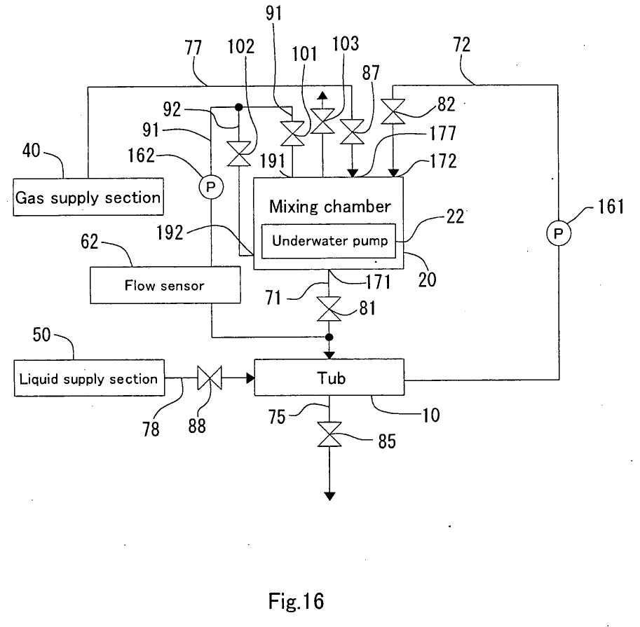

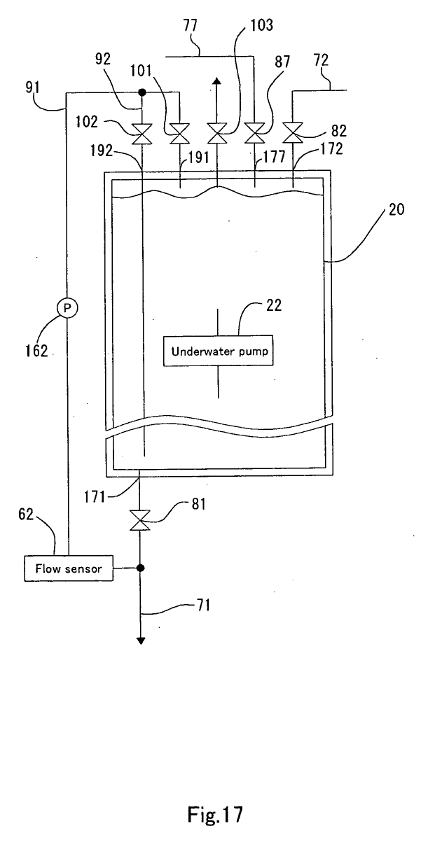

FIG. 16 is a diagram which shows the flow of the gas of liquid according to the bath fluid mixing apparatus which is related to Embodiment 5 of the present invention. In addition, FIG. 17 is an illustrative diagram which shows the perimeter of the mixing chamber 20 for this mixing process.

Instead of the circulating means 30 in the Embodiment 3, the bath fluid mixing apparatus which is related to Embodiment 5 of the present invention differs from Embodiment 3 in that there is provided a water resident pump 22 as a circulating means.

The water resident pump 22 in the bath fluid mixing apparatus which is related to Embodiment 5 is arranged as a circulating means within this mixing chamber 20. This water resident pump 22 mixes the liquid and gas within the mixing chamber 20. Because the water resident pump 22 as a circulating means is arranged within the mixing chamber 20, by utilizing the liquid which is accumulates within the mixing chamber 20, it becomes possible to cool the water resident pump 22 itself. From this cooling, the bath fluid mixing apparatus which is related to Embodiment 5 can make transfers continuously for a long period of time compared to an arrangement whereby the circulating pump is within the mixing chamber 20. In addition, by utilizing the heat that is generated by the driving of the water resident pump 22, it becomes possible to elevate the temperature of the liquid which accumulates within the mixing chamber 20. By this elevation, it becomes possible to reduce the cost of heating by the heater.

Moreover, when it is the case of the mixing chamber which is used for a tub which is related to Embodiment 5, it is permissible to utilize a construction in which there is discharge of the liquid within the mixing chamber 20 by direct connection to the pipe 75 from the mixing chamber number 20.

There is an explanation concerning the bath fluid mixing apparatus which is related to Embodiment 6 of the present invention.

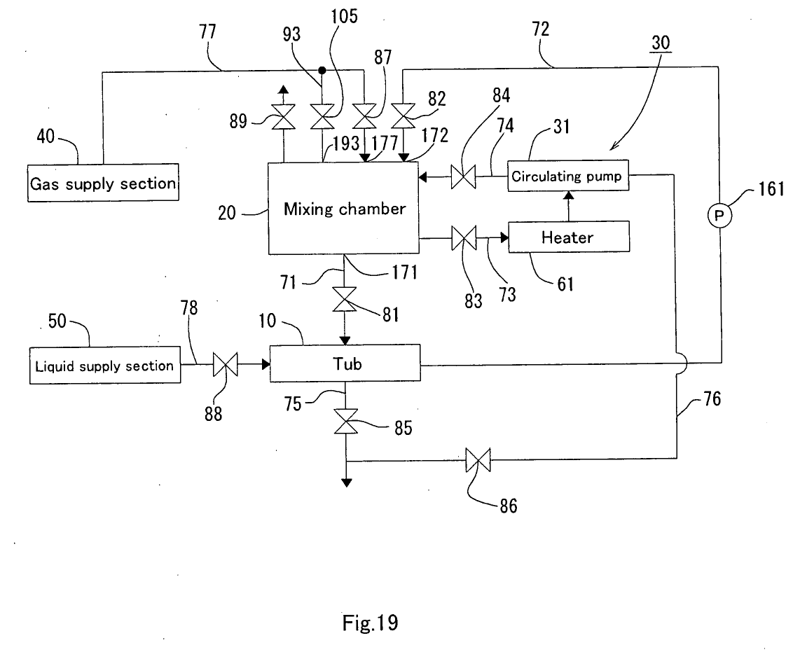

FIG. 19 is a diagram which shows the flow of the liquid and gas according to the bath fluid mixing apparatus which is related to Embodiment 6 of the present invention.

The bath fluid mixing apparatus which is related to Embodiment 6 of the present invention differs from that of the bath fluid mixing apparatus which is related to Embodiment 1 in that with respect to the pipe 77 in the Embodiment 1, there is provided a pipe 93 which is connected from the mixing chamber 20. The pipe 93 is connected to a gas outlet 193 of the mixing chamber 20. A lower end of the gas outlet 193 is arranged not to be immersed in the liquid in the mixing chamber 20. Further, a lower end of the gas inlet 177 is arranged close to the bottom of the mixing chamber 20 so that the liquid bubbles while filling the mixing chamber 20 with the liquid (i.e., gas supply can be initiated before the mixing chamber is filled up with the liquid). The gas moves up to the surface of the liquid, is retained in an upper space, is collected through the gas outlet 193, flows into the gas passing through the pipe 77, and returns to the liquid in the mixing chamber through the gas inlet 177.

The pipe 93 in the bath fluid mixing apparatus which is related to this Embodiment 6 is for the supply of the gas which evaporates in the mixing chamber for the pipe 77 which is connected to the mixing chamber 20 of the gas supply section 40. The open close valve 105 is connected to this pipe 93. Because of this connection, the gas which is not mixed with the liquid in the mixing chamber 20 is supplied once again to the mixing chamber 20 by means of the pipe 93 and the pipe 77. By this connection, it becomes possible to mix with the liquid so that there is no waste of gas when there has not been any mixing with the liquid within the mixing chamber 20. If pressure inside the mixing chamber 20 exceeds a given level, the open close valve 89 opens to release the pressure.

Moreover, the above-mentioned embodiments are of the construction such that the liquid supply section 50 supplies liquid to the tub 10 by means of the pipe 78, but with a construction which supplies the liquid within the circulating means of the liquid which reaches the mixing chamber 20 by means of the supply path 71, the tub 10, and the pipe 72 from the mixing chamber 20, it is permissible to have a construction wherein there is supply to the pipe 72, the mixing chamber 20, the circulating means 30, or the supply path 71.

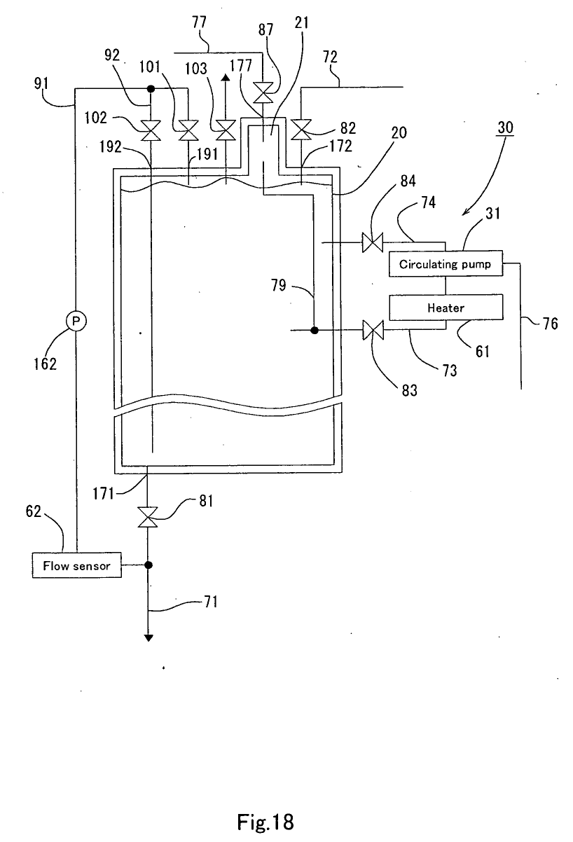

In addition, is permissible that the liquid which flows into the mixing chamber 20 of the discharge path in the above-mentioned embodiments also flows by jet flow. In this case, convection flow is generated within the mixing chamber 20, and it becomes possible to more sufficiently supply the liquid and gas. In this instance, as shown in FIG. 18, there is established a gas collection section 21 in a top portion of the mixing chamber 20, and is permissible to further provide a pipe 79 which connects the gas collection section 21 in the pipe 73. By providing the pipe 79 which connects in this way the gas collection section 21 of the pipe 73, it becomes possible to introduce the necessary gas to the jet flow from within the mixing chamber 20. Thus, it is not necessary to introduce new gas from the outside in order to generate jet flow, and becomes possible to improve the airtightness within the mixing chamber 20.

The gas collection section 21 can be a convex portion formed on the top portion of the mixing chamber 20 so that the convex portion can retain gas therein even when the mixing chamber 20 is filled up with the liquid. In this case, the lower end of the gas inlet 177 is not immersed in the liquid.

In addition, in the bath fluid mixing apparatus which is related to the above-mentioned embodiments, it is assumed that the liquid is supplied to the liquid supply section 50 is warm water, and is assumed that the gas that is supplied to the gas supply section 40 is carbon dioxide, but liquids other than water may be supplied from the liquid supply section 50, and gases other than carbon dioxide may be supplied for the gas supply section 40.

In addition, there is adopted for the bath fluid mixing apparatus which is related to the above-mentioned embodiments a structure which recovers liquid in the mixing chamber 20 from the tub 10, but, for this case, it is permissible to recover the liquid by utilizing a circulation pump which is, for example, a motor and the like. Moreover, when there is utilization of a circulating pump in this way, the circulating pump may be placed on the inside of the tub 10, or it maybe placed on the outside of the 10.

In addition, there is provided, in the bath fluid mixing apparatus which is related to the above-mentioned embodiments, a gas supply section 40 which supplies gas to the mixing chamber 20 by means of the pipe 77, but instead of the gas supply section 40, it is permissible to provide, for the mixing chamber 20, a blood circulation promotion supply section which supplies organogermanium which achieves the effect of promoting circulation of the blood within the body. Also in this case, it becomes possible to dissolve to an appropriate degree in the liquid a blood promotion substance for the mixing chamber 20.

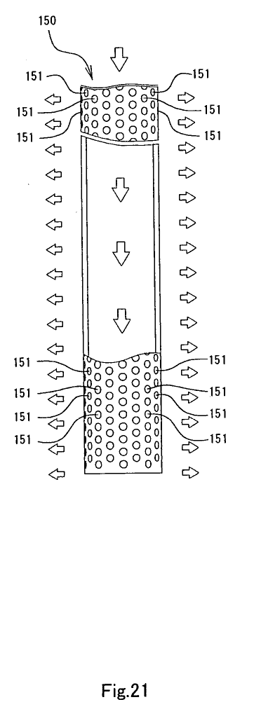

Furthermore, it is permissible to connect the supply pipe 150 which is shown in FIG. 21 to the pipe 72 in the bath fluid mixing apparatus which is related to the above-mentioned embodiments. Numerous holes 151 are placed within the supply pipe 150 which is shown in this FIG. 21. By connecting the supply pipe 150 to the pipe 72, liquid is supplied to the mixing chamber 20 by passing through the numerous holes 151 from the pipe 72. Because of this passage, the liquid is discharged to a shower shape object within the mixing chamber 20, and it becomes possible to elevate the dissolution efficiency.

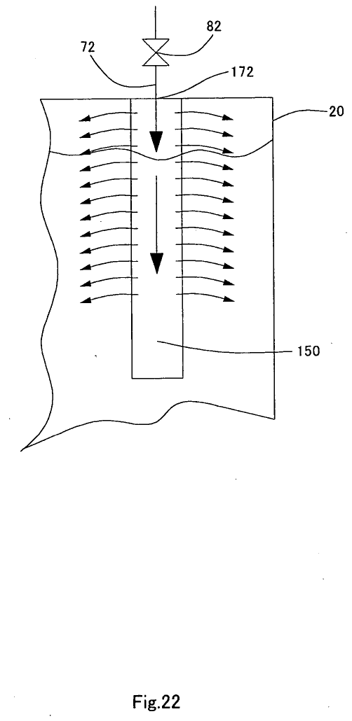

Moreover, if this supply pipe 150 is connected to a part which has been inserted in the mixing chamber 20 for the pipe 72, there is an effect whether or there has been immersion in the mixed liquid as shown in FIG. 22. In FIG. 22, the supply pipe 150 is constructed as an extended portion of the liquid inlet 172. If there has been immersion in the liquid, from the discharge of the liquid from the numerous holes 151, convection flow is generated within the mixing chamber 20. Because of this generation, it becomes possible to sufficiently supply liquid and gas within the mixing chamber 20. In addition, if there has been no immersion in the mixed liquid, the liquid which discharges from the numerous holes 151 makes contact with even more gas. Because of this, it becomes possible to sufficiently supply liquid and gas within the mixing chamber 20.

The present invention includes the above mentioned embodiments and other various embodiments including the following:

1) A bath fluid mixing apparatus characterized by comprising: a tub; a mixing chamber; a liquid supply path for supplying liquid to said tub from said mixing chamber; a liquid recovery path for recovering liquid in said mixing chamber from said tub; a liquid supply section which supplies liquid to a circulating path for liquid which extends from and returns to said mixing chamber via said supply path, said tub, and said recovery path; a gas supply section which supplies gas to said supply path or said mixing chamber; and a circulating means for mixing the liquid and gas in said mixing chamber. According to this embodiment, because there is provided the gas supply section and provides the circulating means, it is possible to mix sufficient gas with the liquid that is supplied to the tub.

2) The bath fluid mixing apparatus as recited in 1), wherein said circulation means comprises: a circulating pump; a flow-in path for flowing-in liquid to said circulating pump from said mixing chamber; and a flow-out path for flowing out liquid to said mixing chamber from said circulating pump. According to this embodiment, because of the circulating means, while construction is easy, it is possible to supply sufficient gas to the liquid which is supplied to the tub.

3) The bath fluid mixing apparatus as recited in 2), wherein a heater is disposed in said flow-in path or said flow-out path. According to this embodiment, because there is established the heater on the flow-in path or flow-out path, it is possible to maintain an appropriate temperature within the tub.

4) The bath fluid mixing apparatus as recited in any of 1)-3), wherein said liquid supply section supplies warm water to said tub. According to this embodiment, because the liquid supply section supplies hot water to the tub, it is possible to supply liquid of an appropriate temperature to the tub.

5) The bath fluid mixing apparatus as recited in any of 1)-4), wherein the gas which is supplied by the gas supply section is carbon dioxide. According to this embodiment, because carbon dioxide is supplied, it is possible to elevate a warm bath effect.

6) The bath fluid mixing apparatus as recited in any of 1)-5), wherein said circulating means comprises a water resident pump which is arranged inside said mixing chamber. According to this embodiment, because the circulating means provides a pipe in the water which is arranged in the interior of the mixing chamber, along with the possibility of cooling the pump itself in the water, there is the possibility of raising the temperature of the liquid which is retained in the interior of the mixing chamber.

7) The bath fluid mixing apparatus as recited in 6), wherein said water resident pump mixes the liquid and gas within said mixing chamber. According to this embodiment, because the pump in the water mixes the liquid and the gas in the interior of the mixing chamber, it is possible to mix sufficient gas efficiently with the liquid which is supplied to the tub.

In the present disclosure where conditions and/or structures are not specified, the skilled artisan in the art can readily provide such conditions and/or structures, in view of the present disclosure, as a matter of routine experimentation.

The present application claims priority to Japanese Patent Application No. 2005-078701, filed Mar. 18, 2005, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A fluid mixing device for a tub comprising a closed mixing chamber having:
a liquid inlet for introducing liquid into the mixing chamber;
a gas inlet for introducing gas into the mixing chamber;
a pressure control valve for controlling pressure inside the mixing chamber; and
a gas-containing liquid outlet for discharging gas-containing liquid from the mixing chamber to a tub.

2. The fluid mixing device according to claim 1, further comprising a circulation device for mixing the liquid and gas in the mixing chamber.

3. The fluid mixing device according to claim 1, wherein the liquid inlet and the gas inlet are constituted by a common inlet.

4. The fluid mixing device according to claim 1, wherein the mixing chamber further has an auxiliary gas-containing liquid outlet for discharging gas-containing liquid from the mixing chamber to the tub.

5. The fluid mixing device according to claim 4, wherein the auxiliary gas-containing liquid outlet is comprised of a first auxiliary gas-containing liquid outlet provided at an upper portion of the mixing chamber and a second auxiliary gas-containing liquid outlet provided at a lower portion of the mixing chamber.

6. The fluid mixing device according to claim 2, wherein the circulation device is disposed outside the mixing chamber.

7. The fluid mixing device according to claim 6, wherein the circulation device is provided with a heater.

8. The fluid mixing device according to claim 2, wherein the circulation device is disposed inside the mixing chamber.

9. The fluid mixing device according to claim 8, wherein the circulation device is water resident pump.

10. The fluid mixing device according to claim 1, wherein the mixing chamber further has a gas outlet for discharging gas from the mixing chamber and returning the gas to the gas inlet.

11. The fluid mixing device according to claim 1, wherein the gas-containing liquid inlet extends inside the mixing chamber.

12. The fluid mixing device according to claim 11, wherein a portion which extends inside the mixing chamber is tubular and has multiple holes for discharging liquid outwardly from the inside of the portion through the holes.

13. The fluid mixing device according to claim 12, wherein the portion has a length which is greater than a half of a depth of the mixing chamber.

14. The fluid mixing device according to claim 2, wherein the mixing chamber has a convex portion for collecting gas therein, and an inlet of the circulation device arranged in the mixing chamber extends to the convex portion.

15. A bath fluid mixing system comprising:
a tub for storing liquid;
a mixing chamber for mixing gas into liquid;
a liquid supply path for supplying gas-containing liquid to the tub from the mixing chamber;
a liquid recovery path for recovering liquid from the tub to the mixing chamber;
a liquid supply section for supplying liquid to a liquid circulation loop constituted by the mixing chamber, the supply path, the tub, and the recovery path;
a gas supply section for supplying gas to the supply path or the mixing chamber; and
a circulation device for mixing the liquid and gas in the mixing chamber.

16. The bath fluid mixing system according to claim 15, wherein the circulation device comprises:
a circulating pump;
a flow-in path for flowing-in liquid to the circulating pump from the mixing chamber; and
a flow-out path for flowing out liquid to the mixing chamber from the circulating pump.

17. The bath fluid mixing apparatus according to claim 15, wherein the flow-in path or the flow-out path is provided with a heater.

18. The bath fluid mixing apparatus according to claim 15, wherein the liquid supply section is configured to supply hot water to the tub.

19. The bath fluid mixing apparatus according to claim 15, wherein the gas supply section is configured to supply carbon dioxide.

20. The bath fluid mixing apparatus according to claim 15, wherein the circulation device comprises a water resident pump which is arranged inside the mixing chamber.

21. The bath fluid mixing apparatus according to claim 15, wherein the liquid recovery path includes a portion which extends inside the mixing chamber and which is tubular and has multiple holes for discharging liquid outwardly from the inside of the portion through the holes.
